(19) United States
(12) Patent Application Publication
(10) Pub. No.: US 2009/0240750 A1
(43) Pub. Date: Sep. 24, 2009

(54) MEMORY SYSTEM AND DATA ACCESS METHOD

(75) Inventor: Dong-Young SEO, Hwaseong-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/408,941

(22) Filed: Mar. 23, 2009

(30) Foreign Application Priority Data
Mar. 24, 2008 (KR) 10-2008-0026950

(51) Int. Cl. G06F 12/02; G06F 12/00

(52) U.S. Cl. 707/205; 711/113; 711/118

(57) ABSTRACT

Disclosed is a memory system including a storage device such a hard disk or flash memory, and an access method. The memory system includes: a storage device storing metadata; a file system generating and managing abstract data associated with the metadata; and a cache memory temporarily storing the abstract data. The file system accesses the metadata of the storage device with reference to the abstract data stored in the cache memory.

### CROSS-REFERENCE TO RELATED APPLICATIONS

This U.S. non-provisional patent application claims priority under 35 U.S.C. § 119 to Korean Patent Application No. 10-2008-0026950 filed on Mar. 24, 2008, the subject matter of which is hereby incorporated by reference.

### BACKGROUND

The present invention relates to memory systems. Particularly, the present invention is directed to memory systems including a data storage device, such a hard disk or flash memory, and a related data access method.

Generic data processing systems usually employ data storage devices storing and facilitating access to data related to text, images, and/or audio information. Traditionally, hard disks or flash memories have been used to implement such storage devices.

Personal computers and consumer electronics incorporating storage devices usually employ one or more file systems designed to facilitate the storage and subsequent access of data. That is, conventional file systems are controlled by software and create data structures and access protocol(s) through which data is written to and read from a storage device. The, so called, file allocation table (FAT) is often used within file systems.

As commonly used, a FAT numerically indicates the location of a data file as stored within a storage device. A constituent operating system (OS) may reference the FAT to identify specific files, file clusters, and/or related indexes and directories stored on the storage device.

FIG. 1 is a conceptual diagram showing one possible structure for a conventional file system including at least one FAT. Referring to FIG. 1, the FAT file system includes a master boot record (MBR) field, a partition boot record (PBR) field, a first FAT (FAT#1), a second FAT (FAT#2), and a clusters field including files and/or directories.

In the illustrated example, the MBR is stored in a first sector of the storage device (e.g., a hard disk). The MBR contains boot code and partition information. The PBR field stores information about each partition. For example, the PBR may contain the number of bytes per sector, the number of sectors per cluster, the number of FATs, and a first cluster associated with a root directory. The FAT#1 stores cluster chain information that indicates which cluster a file is stored. The cluster is the least storage unit allocable to one file. Thus, the cluster is called an ‘allocation unit’. FAT#1 may have the same contents as FAT#2. That is, FAT#2 may act as a backup in the possibility that FAT#1 becomes corrupted.

The cluster field may store a file, a directory, and a directory entry. In the directory entry are stored the first cluster at which the file or directory is located, an attribute, a creation time, a size, and a file or directory name. If there is a file access request from a host, the file system accesses a requested file with reference to the directory entry.

However, directory entries may not be arranged in a regular order within the directory. In order to determine the name of a requested file, for example, it may be necessary to scan through the entire list of directory entries. However, as the number of files stored on the storage device increases, the corresponding number of directory entries becomes large. As the number of directory entries increases, the time required to scan through the list of directory entries also increases. At some point, the length of time required to scan the list of directory entries may cause the performance of the memory system to be degraded.

### SUMMARY OF THE INVENTION

Embodiments of the invention are directed to a memory system having a storage device and capable of locating a directory entry by at least partially abstracting and storing information associated with the directory entries in a cache memory.

In one embodiment, the invention provides a memory system comprising; a storage device storing metadata, a file system generating and managing abstract data at least partially abstracted from the metadata, and a cache memory temporarily storing the abstract data, wherein the file system accesses the metadata of the storage device with reference to the abstract data stored in the cache memory.

In another embodiment, the invention provides an access method for a memory system having a storage device storing a plurality of data files and metadata indicating a location for each one of the plurality of data files, the method comprising; generating abstract data from the metadata, temporarily storing the abstract data in a cache memory, and accessing the metadata of the storage device with reference to the abstract data stored in the cache memory.

### BRIEF DESCRIPTION OF THE FIGURES

FIG. 1 is a diagram showing one possible structure for a conventional FAT file system;

FIG. 2 is a block diagram of one possible hardware organization for a memory system according to an embodiment of the invention;

FIG. 3 is a block diagram showing one possible format for the directory entries of FIG. 2;

FIG. 4 is a conceptual diagram illustrating one method for partially abstracting a filename in accordance with an embodiment of the invention;

FIG. 5 is a table illustrating one possible configuration for the cache memory shown in FIG. 2;

FIG. 6 is a flow chart summarizing one possible cache entry generation method for a memory system according to an embodiment of the invention;

FIG. 7 is a flow chart summarizing one possible cache entry generation method for a memory system according to another embodiment of the invention;

FIG. 8 is a flow chart summarizing one possible file access method for the memory system according to an embodiment of the invention; and

FIG. 9 is a flow chart summarizing one possible file access method for the memory system according to another embodiment of the invention.

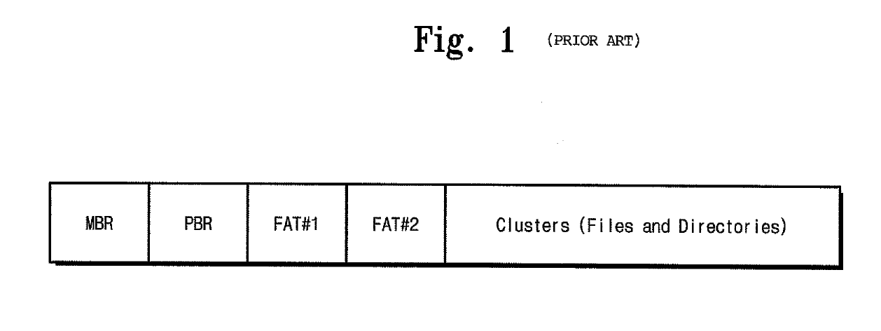

### DESCRIPTION OF EMBODIMENTS

Embodiments of the invention will now be described in some additional detail with reference to the accompanying drawings. The present invention may, however, be embodied in different forms and should not be constructed as being limited to only the illustrated embodiments. Rather, these embodiments are presented as teaching example. Throughout the drawings and written description, like reference numerals are used to indicate like or similar elements, components, and method steps.

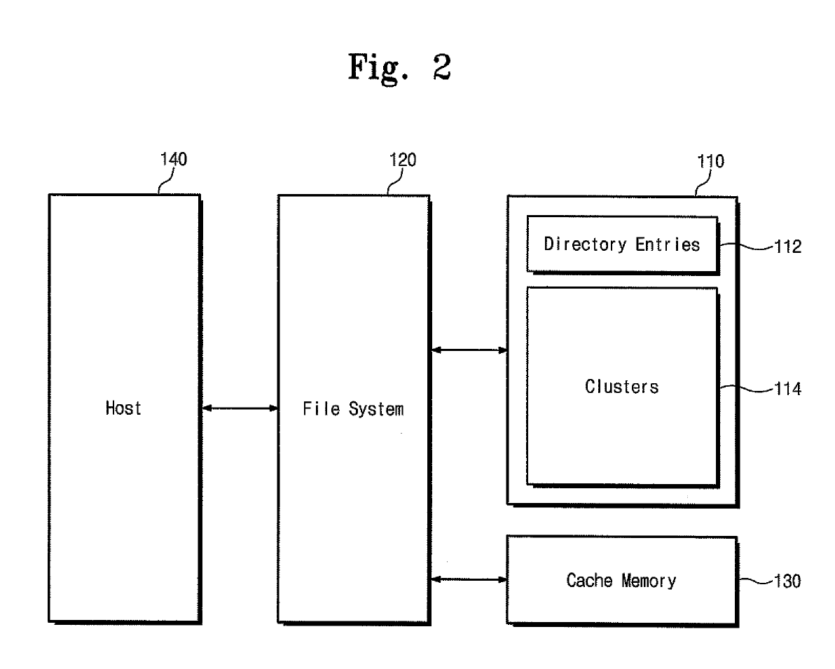

FIG. 2 is a block diagram showing one possible hardware organization for a memory system according to an embodiment of the invention. Referring to FIG. 2, the memory system generally comprises a storage device 110, a file system 120, and a cache memory 130. A host 140 (e.g., a microprocessor, control, or memory controller) is also shown in relation to the memory system components.

In the illustrated embodiment, the storage device 110 includes data storage elements (e.g., flash memory cells and/or hard disk portions) storing data associated with directory entries. Such data storage elements are collectively indicated as a directory entry field 112, and may be contiguous or non-contiguous in their arrangement. Other memory elements are indicted as a cluster field 114. The directory entry field 112 includes, for example, a plurality of directory entries. The structure of the directory entries may vary by design, but will typically contain certain “attributes”, such as filename, file size, file location, etc. A directory entry may be a kind of metadata. The cluster field 114 includes, for example, a plurality of clusters. Each cluster may be used to store, for example, a data file.

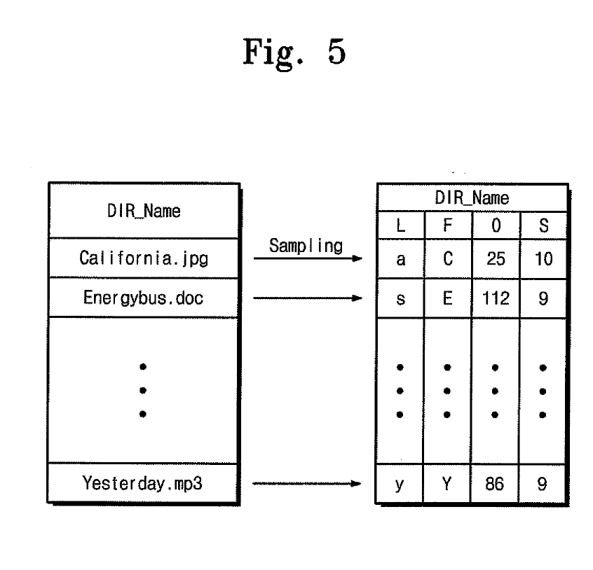

The file system 120 at least partially abstracts the plurality of directory entries and stores the abstracted directory entries in the cache memory 130. In this configuration, cache memory 130 stores a plurality of corresponding cache entries. In one embodiment of the invention, each cache entry includes information abstracted from one or more directory entries. One possible structure for the cache entries will be described in relation to FIG. 5 hereafter.

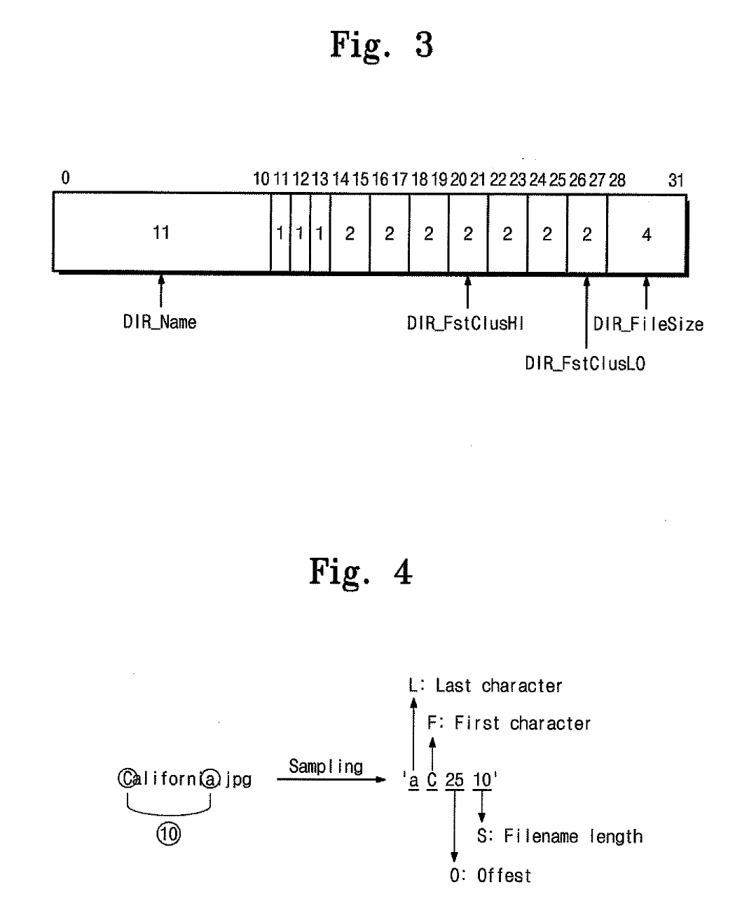

FIG. 3 is a conceptual diagram showing one possible format for one of the plurality of directory entries shown in FIG. 2. Referring to FIG. 3, the directory entry is 32 bytes long. In the illustrated example, the numbers over the respective byte block represent “offsets” while the numbers within each byte block indicate the size of the byte block. The illustrated directory entry includes information such a filename (“DIR_Name”), a location of the first cluster (“DIR_FstClusHI” or “DIR_FstClusLO”), and a file size (“DIR_FileSize”). While the directory entry may include information related to many other file attributes, the foregoing examples are deemed sufficient to the following explanation which merely teaches through specific example a more general concept.

The filename (DIR_Name) in the illustrated example has a size of 11 bytes. Some filenames may be divided into a filename and an extension. The first cluster locations (DIR_FstClusHI and DIR_FstClusLO) have a collective size of 4 bytes. The first cluster location indicates the position of the first cluster at which the data file is stored. The file size (DIR_FileSize) has a size of 4 bytes. The file size identifies the corresponding size the data file as measured in a defined unit, such as bytes.

According to the illustrated embodiment of the invention, the file system abstracts, at least in part, the filename (as one example of a file attribute) and stores the abstracted filename in cache memory 130. One possible method for partially abstracting the filename within the file system will be described with reference to FIG. 4.

FIG. 4 is a conceptual diagram illustrating one possible method of at least partially abstracting a filename in accordance with an embodiment of the invention. In FIG. 4, it is assumed that the abstraction method is performed in relation to a data file having the filename (DIR_Name) of ‘California.jpg’. The filename (DIR_Name) is divided into a filename and an extension. That is, ‘California’ is the filename and ‘jpg’ is the extension. In one related embodiment of the invention, the method abstracts a last character “L”, a first character “F”, an offset “0”, and a filename length “S” from the filename. Here, the offset represents a location of the directory entry corresponding to the data file. But, the present invention is not restrictive to only this approach. For instance, the offset may be abstracted from an arbitrary ordered character of the filename.

As shown in FIG. 4, ‘aC2510’ is abstracted from ‘California.jpg’, where ‘a’ is the last character of the filename, ‘C’ is the first character, ‘25’ is the offset, and ‘10’ is the filename length. In one embodiment of the invention, the abstracted data file value of ‘aC2510’ forms the corresponding cache entry in cache memory 130. One possible configuration for cache memory 130 will now be described in conjunction with FIG. 5.

FIG. 5 is a table containing the cache memory configuration shown in FIG. 2. Referring to FIGS. 2 and 5, cache memory 130 stores a plurality of cache entries. Each cache entry is composed of the last character “L”, the first character “F”, an offset “O”, and a filename length “S”. As aforementioned, the offset represents a location of the directory entry corresponding to the data file. For example, ‘aC2510’ means that: the last character of the filename is ‘a’; the first character of the filename is ‘C’; and the directory entry corresponding to the data file whose filename length is ‘10’ is located at the 25^{th} cluster.

If there is a file access from host 140, file system 120 compares the requested filename with successive cache entries after at least partially abstracting the request filename.

If the abstracted filename is identical to a cache entry, the file system 120 accesses a corresponding directory entry of the storage device 110 with reference to the offset of the cache entry. The file system 120 then compares the requested data filename with a filename of the directory entry. If the filename of the directory entry is identical to the requested data filename, file system 120 accesses the corresponding data file with reference to a data file location of the directory entry. Unless the filename of the directory entry is identical to the requested data filename, file system 120 repeatedly abstracts and compares the requested data filename to the next cache entry.

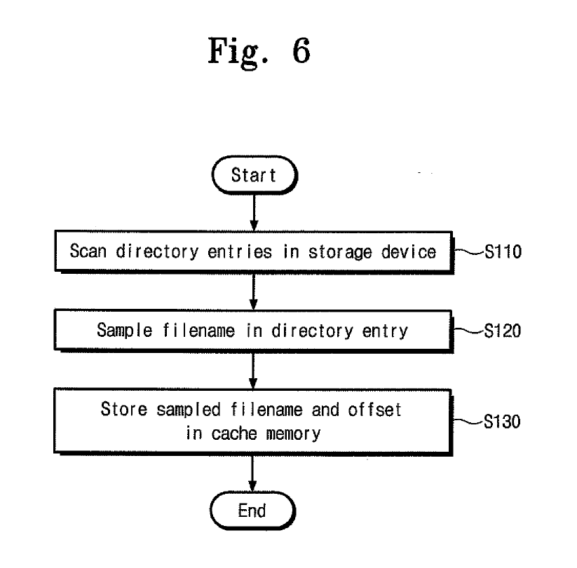

FIG. 6 is a flow chart summarizing one possible cache entry generation method for a memory system in accordance with an embodiment of the invention.

In a first step (S110), file system 120 scans a directory entry field 112 of the storage device 110. That is, file system 120 detects a filename and a location of its corresponding directory entry from the directory entry field 112.

Next, the file system 120 partially abstracts the detected filename and converts the abstracted filename into a cache entry (S120). The method of at least partially abstracting the filename by means of file system 120 may vary with design, but may follow the foregoing example of FIG. 4.

Then, the file system 120 stores the cache entry in the cache memory 130 in the form of the table shown in FIG. 5 (S130). As noted above, the offset indicates a location of the directory entry corresponding to the data file.

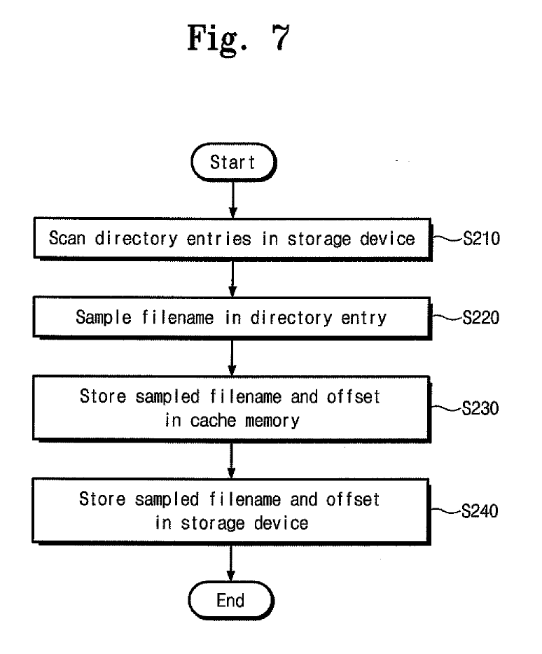

FIG. 7 is a flow chart summarizing a cache entry generation method for a memory system according to another embodiment of the invention.

First, the file system 120 scans a directory entry field 112 of the storage device 110 (S210). That is, the file system 120 detects a filename and a location of its corresponding directory entry from the directory entry field 112.

Then, the file system 120 at least partially abstracts the detected filename and converts the abstracted filename into a cache entry (S220). The method may partially abstract a filename by the file system has been aforementioned in conjunction with FIG. 4.

Then, the file system 120 stores the cache entry in the cache memory 130 in the form of the table shown in FIG. 5 (S230).

Then, the file system 120 stores the cache entry in an arbitrary field of the storage device 110 (S240). Thus, it is permissible to load a cache entry into cache memory 130 from storage device 110 without the need to create a cache entry every time the memory system is accessed. As a result, the memory system operates more efficiently without the repetitive and unnecessary generation of cache entries.

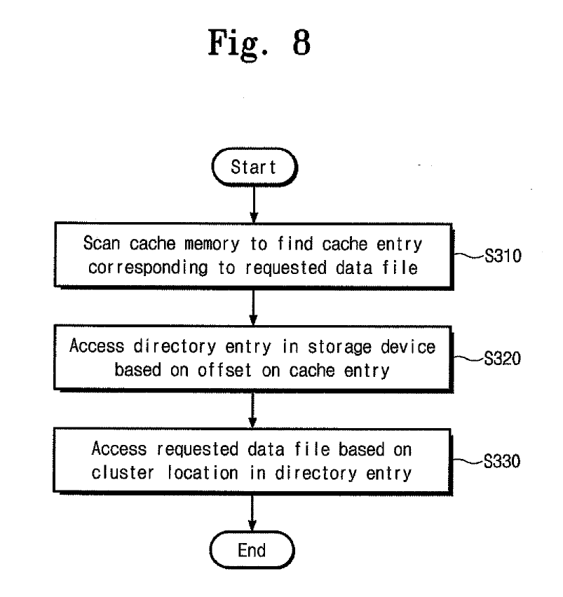

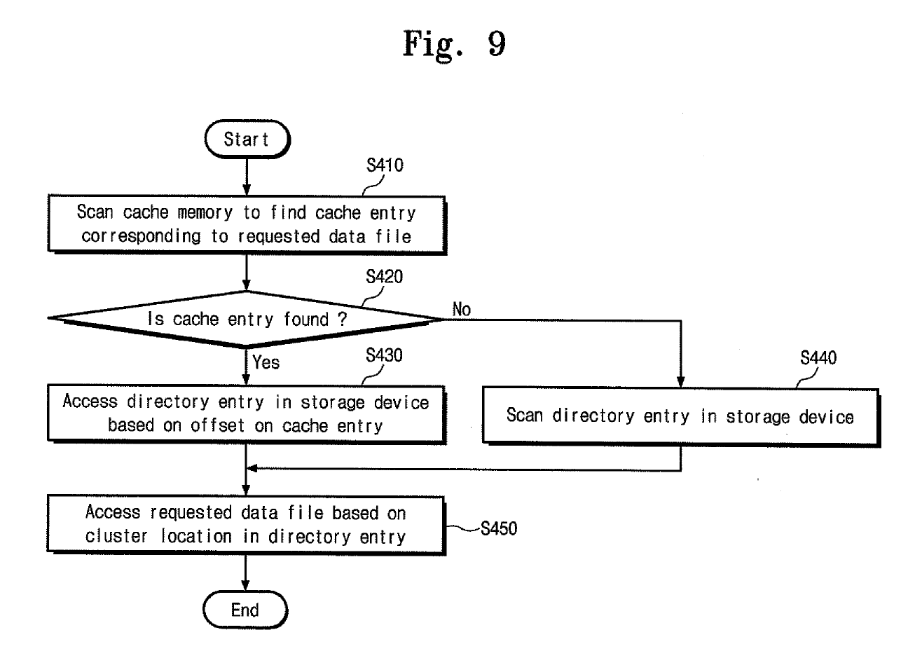

FIG. 8 is a flow chart summarizing a file access method for a memory system in accordance with an embodiment of the invention.

First, file system 120 scans cache memory 130 in order to find out a cache entry corresponding to a requested data file (S310). If the cache entry is found in correspondence with the requested data file, then file system 120 accesses a directory entry in the storage device 110 with reference to the offset of the corresponding cache entry (S320). Then, file system 120 accesses the data file with reference to cluster location information of the directory entry (S330).

FIG. 9 is a flow chart summarizing a file access method for a memory system in accordance with an embodiment of the invention.

First, file system 120 scans the cache memory 130 in order to find out a cache entry corresponding to a requested data file (S410). Then, it determines whether the cache entry is found out in correspondence with the requested data file (S420). If file system 120 detects the cache entry corresponding to the requested data file step S430 is executed, otherwise step S440 is executed. A case that a cache entry is not found out in correspondence with a requested data file is occurable when cache memory 130 is small in size.

File system 120 accesses a directory entry of the storage device 110 with reference to an offset of the corresponding cache entry (S430). Otherwise, file system 120 scans the directory entry field 112 of the storage device 110 (S440).

Then, file system 120 accesses the data file with reference to cluster location information of the directory entry (S450).

Memory systems according to embodiments of the invention store at least partially abstracted information (e.g., filename) of the directory entry in a corresponding cache memory 130. If there is a data file request by host 140, file system 120 detects location information of the directory entry corresponding to the requested data file with reference to cache memory 130. Then, file system 120 accesses the directory entry with reference to the detected location information. Unless cache memory 130 includes a cache entry corresponding to the requested data file, file system 120 scans directory entry field 112 of storage device 110. Finally, file system 120 accesses the data file with reference to the directory entry.

As described above, it shortens a time for searching a directory entry by partly storing information of the directory entry in cache memory. Moreover, it reduces a required capacity of a cache memory by partly storing information of directory entries into the cache memory. As a result, it raises the integration density of the memory system.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A memory system comprising:
a storage device storing metadata;
a file system generating and managing abstract data at least partially abstracted from the metadata; and
a cache memory temporarily storing the abstract data,
wherein the file system accesses the metadata of the storage device with reference to the abstract data stored in the cache memory.

2. The memory system of claim 1, wherein the metadata comprises a plurality of data files, each having a filename and a corresponding location within the storage device.

3. The memory system of claim 2, wherein each abstract data associated with a data file comprises a portion of the filename and a portion of the corresponding location.

4. The memory system of claim 3, wherein the portion of the filename comprises at least one character selected from the filename.

5. The memory system of claim 4, wherein the abstract data further comprises a length value associated with the filename.

6. The memory system of claim 5, wherein the file system stores a first character of the filename, a last character of the filename, and the length value associated with the filename, and a location within the metadata corresponding to the data file into the cache memory.

7. The memory system of claim 6, wherein the file system stores the portion of the filename and the location within the metadata corresponding to the data file into the storage device.

8. The memory system of claim 2, wherein the file system scans a list of abstract data stored in the cache memory to identify a location within the metadata corresponding to a target data file requested by a host.

9. The memory system of claim 8, wherein the file system accesses the metadata of the storage device with reference to the location of the metadata.

10. The memory system of claim 9, wherein the file system accesses the data file of the storage device with reference to the data file location stored in the metadata.

11. The memory system of claim 8, wherein the file system scans metadata of the storage device in sequence unless the metadata corresponding to the target data file is identified after scanning the abstract data in the cache memory.

12. The memory system of claim 11, wherein the file system accesses the data file of the storage device with reference to the data file location stored in the metadata.

13. An access method for a memory system having a storage device storing a plurality of data files and metadata indicating a location for each one of the plurality of data files, the method comprising:
generating abstract data from the metadata;
temporarily storing the abstract data in a cache memory; and
accessing the metadata of the storage device with reference to the abstract data stored in the cache memory.

14. The access method of claim 13, further comprising:
accessing one of the plurality of data files with reference to a corresponding data file location stored in the metadata.

15. The access method of claim 14, wherein the metadata comprises a filename for each one of the plurality of data files,
and generating the abstract data comprises:
abstracting a last character from the filename;
abstracting a first character from the filename;
abstracting a location of the metadata in relation to a data file; and
abstracting a length for the data file.

16. The access method of claim 13, further comprising:
storing the abstract data in the storage device.

17. The access method of claim 13, further comprising:
scanning the abstract data stored in the cache memory to identify a location of metadata corresponding to a target data file requested by a host.

18. The access method of claim 17, further comprising:
accessing the metadata of the storage device with reference to the location of the metadata.

19. The access method of claim 17, further comprising:
sequentially scanning metadata of the storage device unless the metadata corresponding to the target data file is identified after scanning the summary information from the cache memory.
